(19) United States
(12) Patent Application Publication
(10) Pub. No.: US 2019/0063841 A1
(43) Pub. Date: Feb. 28, 2019

(54) MOTOR VEHICLE HEAT EXCHANGER COMPRISING A HEADER TANK

(71) Applicant: Valeo Systemes Thermiques, Le Mesnil Saint Denis (FR)

(72) Inventors: Nicolas Vallee, Bazancourt (FR); Frederic Wascat, Le Mesnil Saint Denis (FR); Jean-Jacques Garcia, Le Mesnil Saint Denis (FR); Stephane Potteau, Le Mesnil Saint Denis (FR); Nicolas Cormet, Le Mesnil Saint Denis (FR)

(73) Assignee: Valeo Systemes Thermiques, Le Mesnil Saint Denis (FR)

(21) Appl. No.: 15/780,200

(22) PCT Filed: Nov. 30, 2016
(86) PCT No.: PCT/EP2016/079317

§ 371 Date: Nov. 2, 2018

(30) Foreign Application Priority Data
Nov. 30, 2015 (FR) 1561570

(51) Int. Cl. F28D 1/053; F28F 9/02; B60H 1/00

(52) U.S. Cl. CPC F28D 1/05375; F28F 2270/02; B60H 1/00328; F28F 9/0226

(57) ABSTRACT

The invention relates to a heat exchanger (1), in particular for a motor vehicle, comprising a header tank (9a) and a bundle of tubes, said header tank (9a) comprising a collector plate (21), a cover (23) and a seal located between the collector plate (21) and the cover (23), said header tank (9a) being divided into two compartments (15a and 15b) by a transverse partition (17), said compartments (15a and 15b) being configured to communicate respectively with two parts of the bundle, said seal isolating said compartments (15a and 15b) from one another and partially closing off the opening of at least one tube, said partially closed-off tube (51), opening into said header tank (9a) near said transverse partition (17).

The present invention has as its object a heat exchanger comprising a header tank, in particular for a vehicle, in particular for a motor vehicle.

Heat exchangers comprising a bundle of tubes disposed between two header tanks are known in this field. The header tanks comprise a collector plate, a seal and a cover assembled together. One of the header tanks is divided into two compartments by a transverse partition. One part of the seal makes it possible to insulate the compartments from one another. Each of the compartments communicates with a first or a second part or pass of the bundle of tubes, thereby defining a so-called U-shaped flow. This type of exchanger and header tank is depicted in FIGS. 2a to 2c.

These exchangers convey the same fluid, but at a different temperature in each pass.

In the case where the temperatures are very different, the tubes of the first pass and the tubes of the second pass experience a different expansion generating constraints in the area of the tubes, in particular their openings in the area of contact with the collector plate. These constraints are even greater with regard to the tubes situated in the interface zone between the two passes. The latter are subjected to a larger thermal shock, which may give rise to leaks or to a rupture between the open part of the tubes and the collector plate.

A number of solutions exist to resolve this problem. It is accordingly known to reinforce the open part of the tubes, in particular by inserting an element into the interior of the tube. These methods accordingly require numerous supplementary elements making the manufacture of suchlike exchangers more complicated.

It has also been proposed to separate the two parts by an inactive tube forming a thermal barrier. An inactive tube, also referred to as a dead tube, is a tube in which no fluid circulates. This solution has the disadvantage of passing on the thermal shock onto the tubes adjacent to the inactive tube, while noticeably penalizing the thermal performance at the surface of a given exchanger.

The need exists, therefore, for a heat exchanger addressing the aforementioned shortcomings, in particular an exchanger in which the thermal shock between the two parts of the bundle is reduced.

The invention proposes for this purpose a heat exchanger, in particular for a motor vehicle, comprising a header tank and a bundle of tubes, said header tank comprising a collector plate, a cover and a seal located between the collector plate and the cover, said header tank being divided into two compartments by a transverse partition, said compartments being configured to communicate respectively with two parts of the bundle, said seal isolating said compartments from one another and partially closing off the opening of at least one tube, said partially closed-off tube opening into said header tank near said transverse partition.

The expression “near” is used to denote the one or more tubes in the vicinity of, that is to say the one or more tubes opening closest to the partition. In other words, the one or more said tubes opening into said header tank near said transverse partition are situated in the interface zone between the two parts of the bundle, the interface zone possibly comprising a plurality of tubes to either side of the transverse partition. The interface zone is defined in terms of its surface in relation to the total surface of the bundle of the exchanger, rather than in terms of the number of tubes. For example, for an exchanger containing a single partition separating the bundle into two substantially equal parts, the interface zone is the central third of the surface of the bundle.

By partially closing off at least one tube of the bundle situated near said transverse partition, the rate of flow of the fluid is reduced and the difference in temperature between the two parts of the bundle in the area of the partially closed-off tubes is lowered. The difference in expansion in the interface zone between the two parts is thus smaller, and the risks of leaks or rupture between the extremities of the tubes and the collector plate are reduced. This being the case, the one or more said tubes are still involved in the thermal exchange.

According to different embodiments of the invention, which may be considered together or separately:
said partially closed-off tube is the tube opening closest to the transverse partition into the compartment of the header tank,
said seal is configured in order for the one or more said partially closed-off tubes to be situated on one side of the transverse partition,
said seal is configured in order for the one or more said partially closed-off tubes to be situated to either side of the transverse partition,
said seal is configured in order for the one or more said tubes to be partially closed off in a symmetrical manner, in relation to a plane intersecting the flow cross-section of the tube depending on its length, into two substantially equal parts,
said seal is configured in order for the one or more said tubes to be partially closed off in an asymmetrical manner, in relation to a plane intersecting the flow cross-section of the tube depending on its length, into two substantially equal parts,
said seal comprises a closing part partially closing off the opening of the one or more said partially closed-off tubes,
said seal is configured in order to impart in addition peripheral sealing between the plate and the cover,
said seal is substantially rectangular in shape having two large sides and two small sides,
said closing part comprises a transverse strap extending between the two large sides of the seal,
said closing part is located on said strap,
said closing part is a localized widening of said strap,
said closing part comprises at least one tongue adapted to close off partially the opening of the one or more said partially closed-off tubes,
said seal comprises at least two straps extending between the two large sides of said seal,
said at least two straps are connected via the one or more said tongues,
said transverse partition comprises at least one means of support adapted to apply pressure to said seal in the area of one or more of said partially closed-off tubes,
the one or more said means of support are grooves perpendicular to said transverse partition,
said grooves are configured in order to extend in the direction of the partially closed-off tubes,
said transverse partition comprises two of said grooves,
said transverse partition comprises four of said grooves,
the one or more said grooves are situated near extremities of said transverse partition,
the one or more said grooves are situated on the same half of said transverse partition,
the one or more said grooves extend to either side of said transverse partition,
said seal extends between each of the grooves,
said transverse partition comprises two parallel walls connected via a face bearing against the seal,
at least one of the two walls is situated in such a way as to apply pressure to said seal in the area of one or more of said partially closed-off tubes,
said seal is configured in such a way as to extend on one side of said transverse partition,
said seal comprises an alignment failsafe extending on one side of said transverse partition,
said exchanger is configured in order to permit the circulation in series of a fluid from one of the parts of the bundle communicating with one of the two compartments of said header tank, to the other part of said bundle,
the one or more said tubes are partially closed off at each of their openings,
said seal of each of the two header tanks partially closes off the opening of at least one tube,
the one or more said partially closed-off tubes have a reduced flow cross-section depending on their width,
the one or more said partially closed-off tubes have a reduced flow cross-section depending on their length,
between 25 and 75% of the section of one or each of said partially closed-off tubes is closed off,
preferably 50% of the section of one or each of said partially closed-off tubes is closed off,
one of the two parts, known as the hot part, is at a temperature greater than the temperature of the other part, known as the cold part,
the one or more said partially closed-off tubes are situated to the side of said hot part,
said heat exchanger comprises in addition at least one partially closed-off tube in said cold part.

The invention will be more readily understood, and other aims, details, characterizing features and advantages of the latter will emerge more clearly in the course of the following detailed explanatory description of at least one embodiment of the invention given by way of purely illustrative and non-exhaustive example and with reference to the accompanying schematic drawings.

In these drawings:

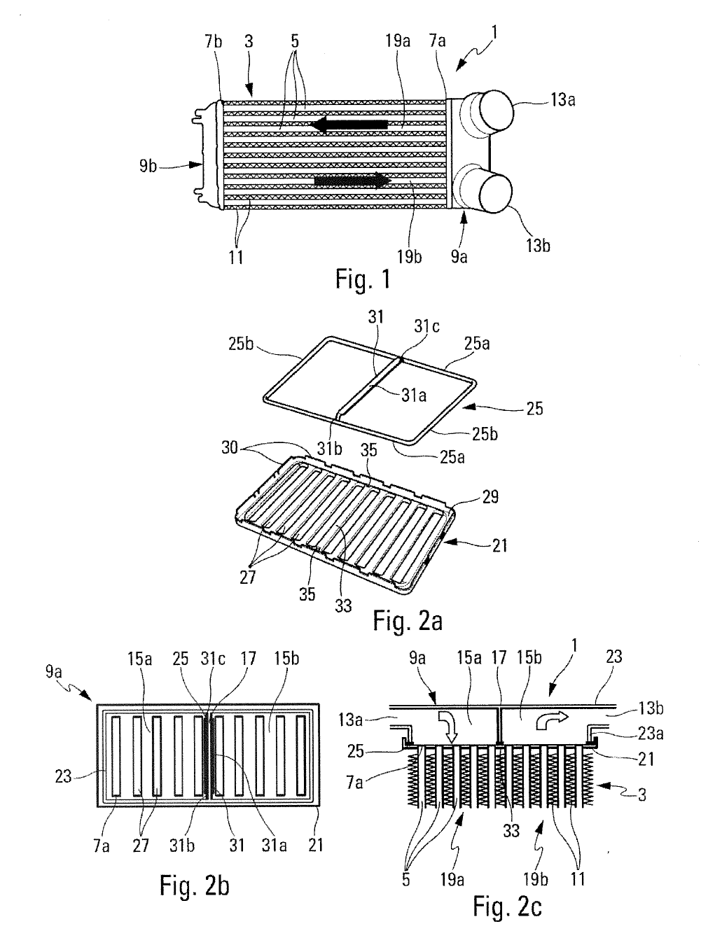

FIG. 1 is a view in perspective of a heat exchanger according to the invention,

FIGS. 2a to 2c represent the prior art:

FIG. 2a is a view in perspective of a collector plate and a seal for a header tank,

FIG. 2b is a schematic view of the top of a header tank comprising the collector plate and the seal in FIG. 2a,

FIG. 2c is a sectioned schematic view from the side of a part of a heat exchanger comprising the header tank in FIG. 2b,

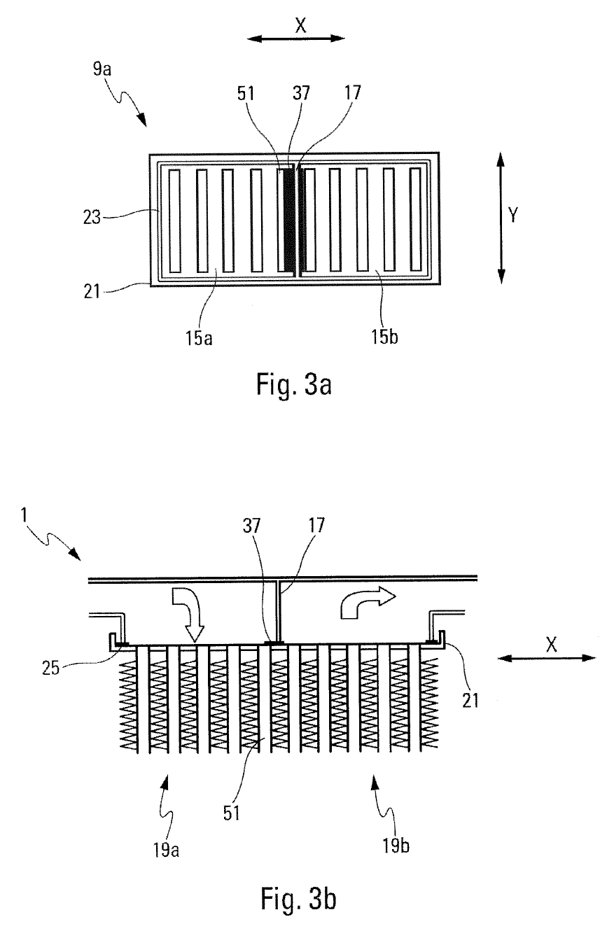

FIGS. 3a and 3b represent a first embodiment of a header tank in accordance with the invention:

FIG. 3a is a schematic view of the top of said header tank,

FIG. 3b is a sectioned schematic view from the side of a part of a heat exchanger comprising the header tank in FIG. 3a,

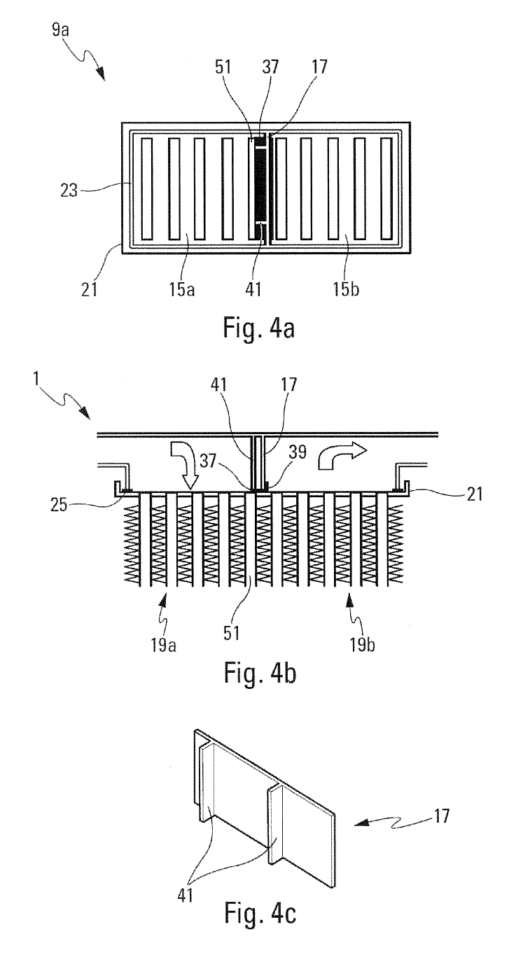

FIGS. 4a and 4b are figures similar to FIGS. 3a and 3b representing a second embodiment in accordance with the invention,

FIG. 4c is a schematic view in perspective of a transverse partition for the header tank in FIGS. 4a and 4b,

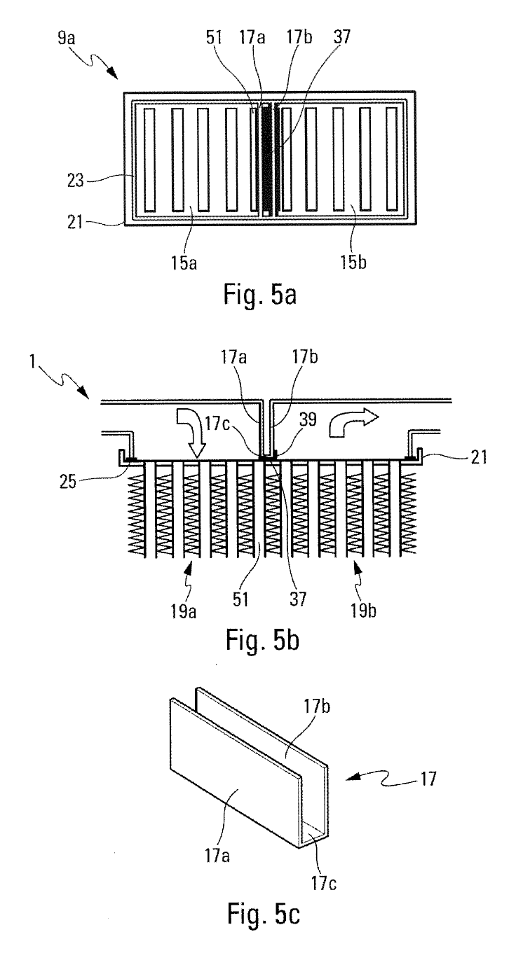

FIGS. 5a and 5b are figures similar to FIGS. 3a and 3b representing a third embodiment of the invention,

FIG. 5c is a schematic view in perspective of another transverse partition for the header tank in FIGS. 5a and 5b,

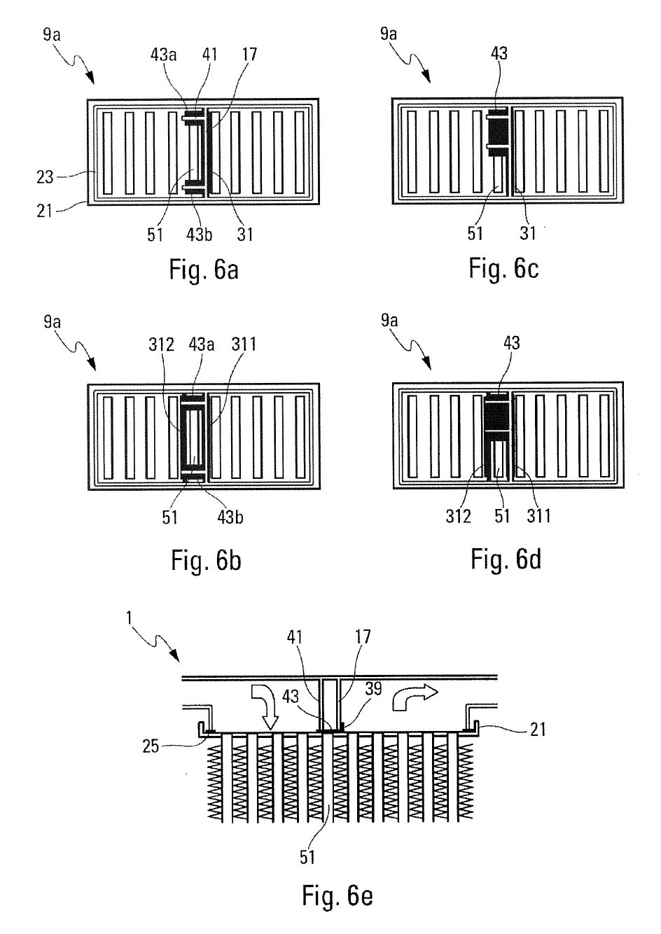

FIGS. 6a to 6d and 6e, are figures similar to FIG. 3a, respectively 3b, representing four variants of a fourth embodiment of the invention,

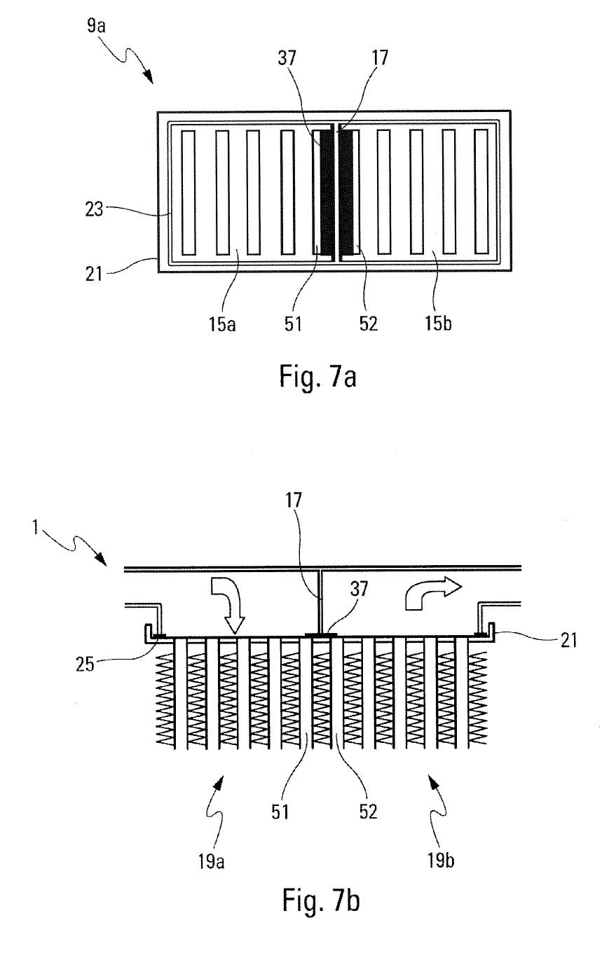

FIGS. 7a and 7b are figures similar to FIGS. 3a and 3b representing a fifth embodiment of the invention,

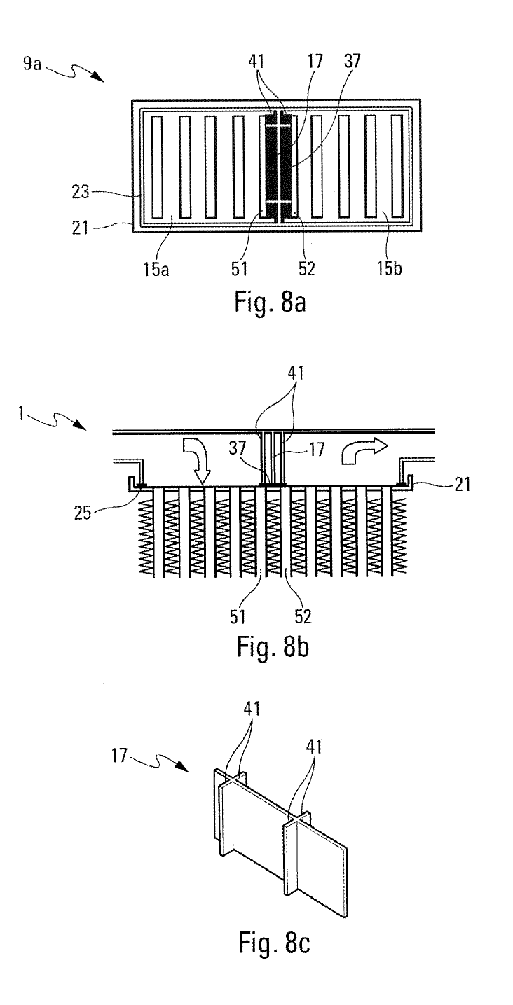

FIGS. 8a and 8b are figures similar to FIGS. 3a and 3b representing a sixth embodiment of the invention,

FIG. 8c is a schematic view in perspective of a transverse partition for the header tank in FIGS. 8a and 8b,

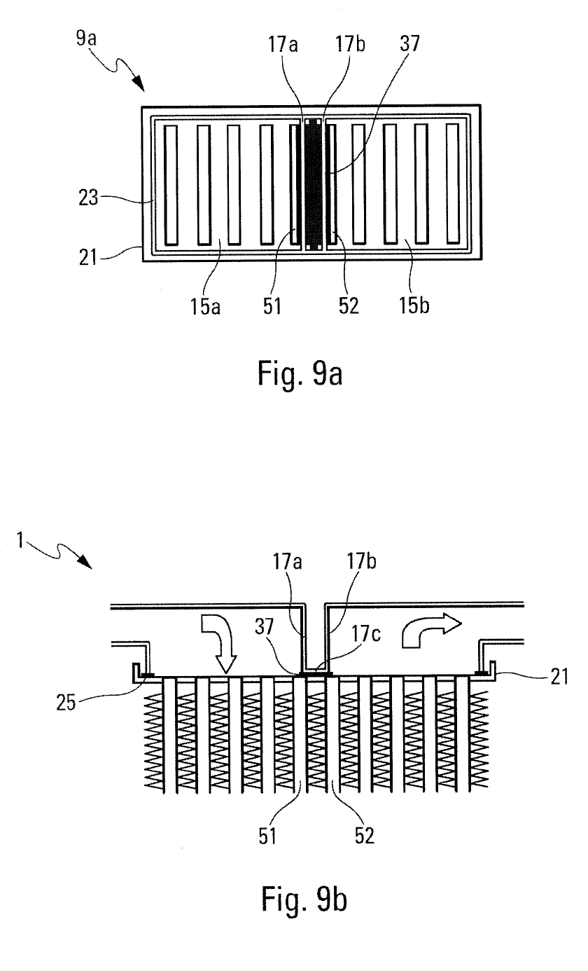

FIGS. 9a and 9b are figures similar to FIGS. 3a and 3b representing a seventh embodiment of the invention,

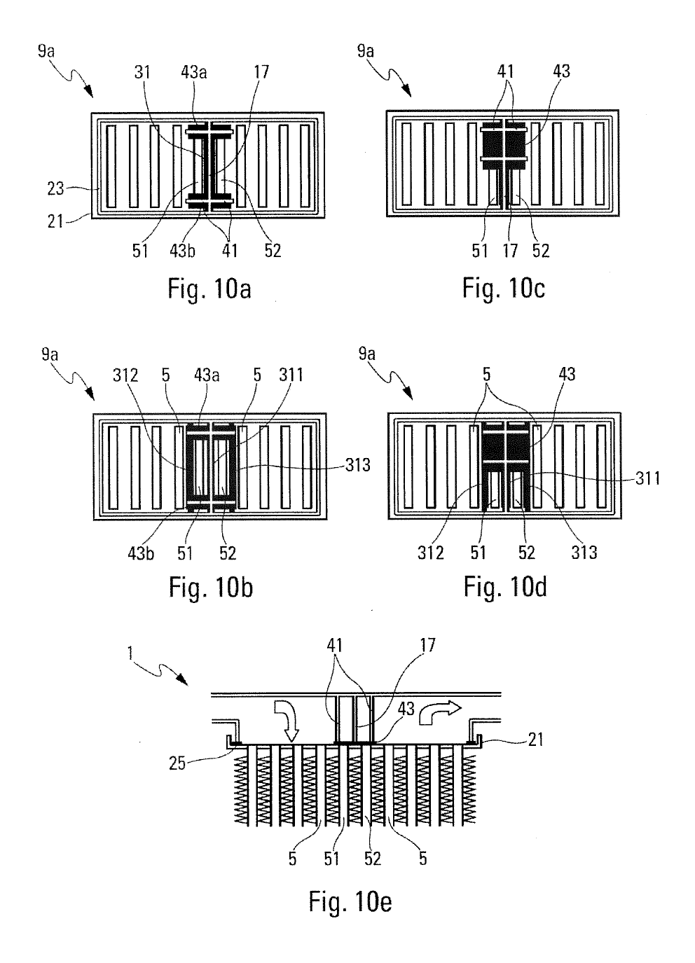

FIGS. 10a to 10e are figures similar to FIGS. 3a and 3b representing an eighth embodiment of the invention.

As illustrated in FIGS. 1 and 2a to 2c, the invention finds applications in a heat exchanger 1, in particular a heat exchanger 1 for a vehicle, permitting the exchange of heat between a first fluid and a second fluid. The heat exchanger is preferably a heat exchanger 1 of which the flow is described as being U-shaped.

Said exchanger 1 comprises a bundle 3 of tubes 5 in which the first fluid circulates. The tubes 5 of the exchanger 1 are flat, for example, and comprise two large opposing parallel plane faces, connected via lateral edges of the tube 5. The distance between the lateral edges of the tube 5 is referred to as the length of the tube, and the distance between the two large faces of the tube 5 is referred to as the width. Each tube 5 comprises two openings 7a and 7b opening into first and second header tanks 9a and 9b.

The terminology may be defined as follows:
Reducing the flow cross-section of a tube 5 depending on its width is equivalent to replacing it virtually by a tube, of which the flow cross-section is of smaller width and of the same length, by sacrificing a longitudinal part of its flow cross-section. This involves closing off the opening 7a, 7b of the tube for the whole of its length, and for only a part of its width.
Reducing the flow cross-section of a tube 5 depending on its length is equivalent to replacing it virtually by a tube, of which the flow cross-section is of smaller length and of the same width, by sacrificing a lateral part of its flow cross-section. This involves closing off the opening 7a, 7b of the tube for the whole of its width, and for only a part of its length.

If the tube 5 is not flat and contains an elliptical flow cross-section, for example, the width is understood to be the distance of the segment that is defined by the small axis of its flow cross-section, and the length is understood to be the distance of the segment that is defined by the large axis of its flow cross-section.

Thus:
Reducing the flow cross-section of a tube 5 of elliptical section depending on its width is equivalent to replacing it virtually by a tube, of which the flow cross-section is truncated by a straight line parallel to the large axis. Closing off the opening 7a, 7b of the tube in a straight line parallel to the large axis cuts the opening 7a, 7b of the tube into two parts: a part that is closed off and a part that is not closed off.
Reducing the flow cross-section of a tube 5 of elliptical section depending on its length is equivalent to replacing it virtually by a tube, of which the flow cross-section is truncated by a straight line parallel to the small axis. Closing off the opening 7a, 7b of the tube in a straight line parallel to the small axis cuts the opening 7a, 7b of the tube into two parts: a part that is closed off and a part that is not closed off.

The geometry of the flow cross-section is not limited to the two examples referred to above. The flow cross-section of the tube 5 may be square, and this may be a lozenge.

Said tubes 5 may in addition comprise spacers or turbulators, not represented here, disposed in the interior of said tubes 5, in order to improve the thermal exchange and the resistance to the internal pressure of said tubes.

The second fluid circulates between the tubes 5. Spacers 11 may be arranged between these tubes 5, in particular corrugated spacers as represented here. Suchlike spacers 11 make it possible to increase the surface of thermal exchange between the first fluid circulating in said tubes 5 and the second fluid passing through the exchanger 1 between the tubes 5.

Said exchanger 1 may furthermore comprise, for example, an inlet flange 13a and/or an outlet flange 13b for the first fluid. Said flanges 13a and 13b may be situated on each of the header tanks 9a and 9b or on the same header tank, depending on the flow, in a plurality of passes, of the first fluid in the exchanger 1.

In the present invention, the heat exchanger is preferably a heat exchanger 1, of which the flow, the so-called U-shaped flow, is in two passes. In this type of exchanger, one of the header tanks 9a is divided into two compartments 15a and 15b by a transverse partition 17. Each of the compartments 15a and 15b communicates with a first part 19a or a second part 19b of the bundle 3 of tubes, the compartment 15a communicating with the part 19a of the bundle and the compartment 15b communicating with the part 19b of the bundle 3. In other words, said exchanger 1 is configured in order to permit the circulation in series of a fluid in each of the parts 19a and 19b of the bundle 3 communicating with the two compartments 15a and 15b of said header tank 9a.

In this type of exchanger, the inlet flange 13a and the outlet flange 13b are situated on the header tank 9a having double compartments, as represented here. Said first fluid thus enters via the inlet flange 13a into the compartment 15a, which communicates with the first part 19a of the bundle 3, and the fluid is then directed by the second header tank 9b, comprising a single compartment, towards the second part 19b of the bundle 3 communicating with the compartment 15b of the header tank 9a, before eventually exiting from the exchanger 1 via the outlet flange 13b. A U-shaped flow is thus defined for the first fluid. In this way, said fluid is at a different temperature in each pass.

This being the case, the invention relates more particularly to the header tank 9a having double compartments. Said header tank 9a comprises a collector plate 21, a seal 25 and a cover 23 assembled together, the seal 25 being inserted between the cover 23 and the collector plate 21.

Said collector plate 21 exhibits a substantially rectangular shape here and comprises orifices 27 into which the openings 7a of the tubes 5 discharge. Said orifices 27 make it possible to secure the tubes 5 to the header tank 9a. Here, the orifices 27 are aligned in a single row, one parallel to the other, in a direction corresponding to the longitudinal direction of extension of the plate 21. Said orifices 27 of the collector plate 21 have a shape corresponding to the section of the openings 7a of said tubes 5.

In order to assist in maintaining the sealing of said cover 23, said plate 21 includes in this case a groove 29 delimiting its perimeter. The function of said groove 29 is to accommodate said seal 25, intended to be compressed by an edge or foot 23a of the cover, said edge or foot of the cover being inserted into the interior of the groove 29.

Said collector plate 21 comprises in addition means of attachment 30 of the cover 23. These may be crimping teeth 30, for example, as represented here. Said teeth 30 extend along the perimeter of the collector plate 21, from the external edge of the groove 29. These teeth 30 are used to secure the cover 23 on the collector plate 21 in the course of assembly. As already mentioned, the cover may be provided with a foot of the cover situated on the contour of its opening, the latter being capable of being inserted into the groove 29.

In a conventional manner, said seal 25 is configured in order to impart peripheral sealing between the plate 21 and the cover 23. II is substantially rectangular in shape having two large sides 25a and two small sides 25b. It may be in the form of a continuous bead capable of engaging in the groove 29 of said collector plate 21. In FIG. 2a, the seal 25 is represented in its uncompressed state and before assembly on the collector plate 21.

As mentioned previously, said header tank 9a is divided into two compartments 15a and 15b by a transverse partition 17. Said compartments 15a and 15b are configured to communicate respectively with the two parts 19a and 19b of the bundle 3. According to the invention, said seal 25 may also be adapted to insulate said compartments 15a and 15b from one another. It may comprise for this purpose, as represented here, a transverse strap 31, preferably flat. It is attached to the two large sides 25a of the seal 25, substantially at their middles. Said strap 31 is intended to be supported on a transverse part 33 of the collector plate 21 between two successive tubes 5 of the bundle 3, in such a way that, in the course of assembly, the strap 31 is compressed between the collector plate 21 and the transverse partition 17 of the header tank 9a.

Said strap 31 exhibits a central portion 31a of constant section and two extremities 31b and 31c attached to the two large sides 25a of the seal 25. The central portion 31a has a width and a thickness greater than those of the extremities 31b and 31c. Preferably, the width of the strap 31 is greater than the width of the transverse partition 17. In a complementary manner, said collector plate 21 comprises two notches 35 facing one another. These notches 35 are situated on the extremities of the transverse part 33 of the collector plate 21 intended to accommodate said seal 25. These notches 35 are intended to accommodate the extremities 31b and 31c of the strap 31, whereas the central part 31a rests on said transverse part 33 of said collector plate 21, and the rectangular contour of said seal 25 is engaged in the groove 29 of said collector plate 21. This configuration of the seal 25 and of the collector plate 21 ensures the correct positioning of the seal 25 and, as a result, guarantees effective sealing, in particular in the area of said strap 31.

As illustrated in FIGS. 3a, 3b and the following figures, in the present invention, in addition to ensuring sealing between the two compartments 9a and 9b, or indeed sealing between the cover 23 and the collector plate 21, the seal 25 is adapted to close off partially the opening of at least one tube 5 opening into said header tank 9a next to said transverse partition 17. A suchlike tube is referred to below as a partially closed-off tube 51. Taking into consideration the correspondence in shape between the orifices 27 situated in the collector plate 21 and the contour of the tubes, this means that said seal 25 partially covers the one or more said orifices 27 situated next to said partition 17.

In an advantageous manner, the seal 25 comprises a closing part 37 adapted to close off partially the opening 7a of the one or more of said partially closed-off tubes 51. This closing part 37 is made of the same material as the rest of the seal 25, in particular that situated in the area of the partition 17. It extends in this case between the two large sides 25a of the seal 25, without necessarily being attached there. As depicted, this closing part 37 may comprise said strap 31 described previously. The latter thus exhibits a width of the central portion 31a greater than that of the central portion of a seal known from the prior art depicted in FIGS. 2a to 2c. Said strap, which has therefore been enlarged, is thus adapted to close off partially the opening 7a of one or more of said partially closed-off tubes 51. The strap 31 therefore includes a widening located in the central portion 31a.

In an advantageous manner, said closing part 37 is adapted to close off between 25 and 75% of the section of one or each of said partially closed-off tubes 51, preferably 50% of the section being closed off. In other words, between 25 and 75%, preferably 50%, of the section of one or each of said partially closed-off tubes 51 is closed off. Closing off greater than 75% would pass on the problem of thermal shock and the risk of leaks and rupture onto the tube adjacent to the partially closed-off tube 51. Closing off of less than 25% would not permit the flow to be reduced sufficiently and, as a result, the difference in temperature and the difference in expansion between the parts 19a and 19b of the bundle.

In the case of a plurality of partially closed-off tubes on the same side, the closing off of the tube closest to the partition 17 will preferably be greater than the closing off of the tube furthest from the partition 17.

Said partially closed-off tube 51 may preferably be situated in the part 19a, that is to say on the side where the first fluid enters into the heat exchanger 1 or into the part 19b, that is to say on the side where the first fluid exits from the heat exchanger 1. In a general manner, the first fluid in the part 19a is at a temperature greater than the temperature that it exhibits in the part 19b. In this case, the part 19a is known as the hot part, and the part 19b is known as the cold part. In an advantageous manner, the partially closed-off tube 51 is situated on the side of said hot part 19a. This embodiment is depicted in FIGS. 3 to 6, in which a single tube is partially closed off.

It is also conceivable for a plurality of tubes to be partially closed off, in a closing-off section which increases as it approaches more closely to the partition, for example.

In a first embodiment depicted in FIGS. 3a and 3b, said seal 25 is configured in order to close off partially a single tube 51 situated to one side of said hot part 19a. Said seal 25 comprises said strap, of which the central portion 31a is enlarged by said closing part 37 in order to reduce the flow cross-section of the tube 51 depending on its width. In other words, said tube 51 is partially closed off for the whole of its length and for only a part of its width. Said closing part 37 is held in place by the transverse partition 17, which, in the course of assembly, exerts a pressure on the latter. The partition in this case is a simple partition comprising a single, rectilinear wall extending parallel to and between two contiguous tube introduction orifices.

In a second embodiment depicted in FIGS. 4a to 4c, said seal 25 is substantially identical to that of the first embodiment. It comprises in addition an alignment failsafe 39 enabling assembly errors to be avoided. The latter extends on one side of said transverse partition 17, in particular on the side oppose that where the partially closed-off tube 51 is present. In this embodiment, the transverse partition 17 depicted in FIG. 4c is a partition comprising a single wall and means of support 41. The items in question here are two grooves 41 configured in order to apply pressure to said seal 25 in the area of the partially closed-off tube 51 in the course of assembly, that is to say in the area of the closing part 37. The two grooves 41 are perpendicular to said transverse partition 17, for example, and extend in the direction of said partially closed-off tube 51. Said grooves 41 are situated near extremities of said transverse partition 17, the closing part 37 extending at least between each of said grooves 41.

In a third embodiment depicted in FIGS. 5a to 5c, the seal 25 embodies the characterizing features of the previous embodiment. This embodiment is differentiated by the type of partition. In this case, said transverse partition 17, depicted in FIG. 5c, is a double partition, that is to say said transverse partition comprises two parallel walls 17a and 17b connected via a lower face 17c. Said lower face 17c bears against the closing part 37, and one of the two walls (in this case the wall 17a) is situated in such a way as to apply pressure to said closing part 37 in the area of the partially closed-off tube 51.

In a fourth embodiment depicted in FIGS. 6a to 6e, said closing part 37 is configured in order to reduce the flow cross-section of a tube 51 situated on the side of said hot part 19a, depending on its length. A number of variants are possible.

Thus, in the variant in FIG. 6a, said closing part 37 is formed by two tongues 43a and 43b adapted to close off partially the opening of said partially closed-off tube 51. The two tongues 43a and 43b are made of the same material as said strap 31, of which the two extremities of the central portion 31a extend for the entire width of the tube 51, the flow cross-section of the tube 51 then being reduced depending on its length in two separate locations. These two tongues are thus a localized widening of the strap 31 and, more specifically, of the central portion 31a of the strap 31. In other words, said tube 51 is closed off for its entire width by each of said tongues 43a and 43b, reducing the flow cross-section of the tube 51 at each of its lateral extremities. Said closing part 37 is kept in place by the transverse partition 17, which comprises two grooves 41, which are perpendicular to it, for example, extending in the direction of said partially closed-off tube 51. The two grooves 41 are situated near extremities of said transverse partition 17 in such a way as to apply pressure to said tongues 43a and 43b in the course of the assembly of the header tank 9a. Said tongues in this case are situated in a symmetrical manner in relation to a plane intersecting the flow cross-section of the tube 5 depending on its length, in two substantially equal parts.

In the variant in FIG. 6b, said closing part 37 is formed by two tongues 43a and 43b as described in FIG. 6a. In contrast, said seal 25 comprises a second strap 312, parallel to the first 311, extending between the two large sides 25a of said seal 25. The two straps 311 and 312 are thus connected via the two tongues 43a and 43b. The two straps 311 and 312 bear against the collector plate 21 on each side of the partially closed-off tube 51. As in the variant in FIG. 6a, the transverse partition 17 comprises two perpendicular grooves 41 situated in the area of the two tongues 43a and 43b.

In the variant in FIG. 6c, said closing part 37 is formed by a single tongue 43 made of the same material as said strap 31. Thus, the central portion 31a is enlarged on only a part of its length by said tongue 43, which extends for the entire width of the tube 51. The flow cross-section of the tube 51 is thus reduced depending on its length. In other words, said tube 51 is partially closed off for its entire width and for only a part of its length. Again, said closing part 37 is held in place by the transverse partition 17, which comprises two grooves 41, which are perpendicular to it, for example, extending in the direction of said partially closed-off tube 51. The two grooves 41 are situated near extremities of said tongue 43 in such a way as to apply pressure to the latter in the course of the assembly of the header tank 9a. The tongue 43 thus extends at least between the two grooves 41.

In the variant in FIG. 6d, said closing part 37 is formed by a single tongue 43, as described in FIG. 6c. In contrast, said seal 25 comprises a second strap 312, as previously described in the variant in FIG. 6b. The two straps 311 and 312 are thus connected via said tongue. As in the variant in FIG. 6c, the transverse partition 17 comprises two perpendicular grooves 41 situated near extremities of said tongue 43.

In the variants in FIG. 6, the seal 25 may also comprise an alignment failsafe 39, as depicted in FIG. 6e, enabling assembly errors to be avoided.

In the embodiments depicted in FIGS. 7 to 10, said heat exchanger 1 comprises in addition at least one partially closed-off tube 52 in the part 19b, that is to say in said cold part. For this purpose, said seal 25 is configured in order to close off partially two tubes 51 and 52 situated to either side of the transverse partition 17. In other words, a partially closed-off tube 51 is situated on the side where the first fluid enters into the heat exchanger 1, that is to say the hot part 19a, and a second partially closed-off tube 52 is situated on the side where the first fluid exits from the heat exchanger 1, that is to say the cold part 19b.

Again, it is conceivable for a plurality of tubes on the same side to be partially closed off. It is thus conceivable that:
a plurality of tubes are partially closed off in the part 19a, and a single tube is partially closed off in the part 19b (not represented here),
a single tube is partially closed off in the part 19a, and a plurality of tubes are partially closed off in the part 19b (not represented here),
a plurality of tubes are partially closed off in the part 19a, and a plurality of tubes are partially closed off in the part 19b (not represented here).

In a fifth embodiment depicted in FIGS. 7a and 7b, said seal 25 is configured in order to close off partially two tubes 51 and 52 situated to either side of the transverse partition 17, a hot part and a cold part. Said seal 25 comprises said strap 31, of which the central portion 31a is enlarged to either side by said closing part 37 in order to reduce the flow cross-section of both of the tubes 51 and 52, each depending on their width. In other words, the two tubes 51 and 52 are partially closed off for their entire length and for only a part of their width. Said closing part 37 is held in place by the transverse partition 17, which exerts a pressure on the latter in the course of assembly. The partition in this embodiment is a simple partition comprising a single wall 17, as in the embodiment in FIG. 3.

In a sixth embodiment depicted in FIGS. 8a to 8c, said seal 25 is substantially identical to that of the fifth embodiment described previously. In this embodiment, the transverse partition 17 depicted in FIG. 8c is a partition comprising a single wall and means of support 41. The item in question here is two grooves 41 configured in order to apply pressure to said seal 25 in the area of the partially closed-off tubes 51 and 52 in the course of assembly, that is to say in the area of the closing part 37. The two grooves 41 are perpendicular to said transverse partition 17, for example, and extend to either side of the latter in the direction of the two tubes 51 and 52. Said grooves 41 are situated near extremities of said transverse partition 17, the closing part 37 extending at least between each of said grooves 41.

In a seventh embodiment depicted in FIGS. 9a and 9b, the seal 25 embodies the characterizing features of the seals of the two preceding embodiments. In contrast, the transverse partition 17 is a double partition, like that depicted in FIG. 5c, that is to say said transverse partition comprises two parallel walls 17a and 17b connected via a lower face 17c. Said lower face 17c bears against the closing part 37, and the two walls 17a and 17b are situated in such a way as to apply pressure to said closing part 37 in the area of each of said partially closed-off tubes 51 and 52.

In an eighth embodiment depicted in FIGS. 10a to 10e, said closing part 37 is configured in order to close off partially the opening of two tubes 51 and 52 situated to either side of the transverse partition 17 depending on their length, as described previously in the fourth embodiment. A number of variants are possible.

Thus, the variant in FIG. 10a is similar to the variant in FIG. 6a. Said closing part 37 is formed by two tongues 43a and 43b adapted to close off partially the opening of said partially closed-off tubes 51 and 52. The two tongues 43a and 43b are made of the same material as said strap 31, of which the two extremities of the central portion 31a extend to either side of the transverse partition 17 for the entire width of the partially closed-off tubes 51 and 52. In other words, each of the tubes 51 and 52 is closed off by said tongues 43a and 43b, reducing the flow cross-section of the tubes 51 and 52 at each of their openings depending on their length. Said closing part 37 is held in place by the transverse partition 17, which comprises two grooves 41 that are perpendicular to it, for example, extending to either side of the transverse partition 17 in the direction of said partially closed-off tubes 51 and 52. The two grooves 41 are situated near extremities of said transverse partition 17 in such a way as to apply pressure to said tongues 43 in the course of the assembly of the header tank 9a.

In the variant in FIG. 10b, said closing part 37 is formed by two tongues 43a and 43b as described in FIG. 6a. In contrast, said seal 25 comprises a second strap 312 and a third strap 313, parallel to the first strap 311, extending between the two large sides 25a of said seal 25. These two supplementary straps 312 and 313 are situated to either side of the first strap 311 in a symmetrical manner. The three straps 311, 312 and 313 bear against the collector plate 21 between two tubes 5. More specifically, the strap 311 and the strap 312 bear against the collector plate 21 to either side of the partially closed-off tube 51 of the hot part 19a, the strap 311 and the strap 313 bearing against the collector plate 21 to either side of the partially closed-off tube 52 of the cold part 19b. The two partially closed-off tubes 51 and 52 are framed by the second strap 312 and the third strap 313. The three straps 311, 312 and 313 are thus connected via the two tongues 43a and 43b. As in the variant in FIG. 10a, the transverse partition 17 comprises two perpendicular grooves 41 extending to either side of the transverse partition 17 and situated in the area of the two tongues 43a and 43b.

In the variant in FIG. 10c, said closing part 37 is formed by a single tongue 43 made of the same material as said strap 31. Thus, the central portion 31a is enlarged on only a part of its length by said tongue 41, which extends for the entire width of the tubes 51 and 52. Thus, the flow cross-section of the tubes 51 and 52 is reduced depending on their length. In other words, the two tubes 51 and 52 are partially closed off for their width and for only a part of their length. Again, said closing part 37 is held in place by the transverse partition 17, which comprises two grooves 41, which are perpendicular to it, for example, extending to either side of the transverse partition 17 in the direction of said partially closed-off tubes 51 and 52. The two grooves 41 are situated near extremities of said tongue 43 in such a way as to apply pressure to the latter in the course of the assembly of the header tank 9b. The tongue 43 thus extends at least between the two grooves 41.

In the variant in FIG. 10d, said closing part 37 is formed by a single tongue 43, as described in FIG. 10c. In contrast, said seal 25 comprises a second strap 312 and a third strap 313, as previously described in the variant in FIG. 10b. The three straps 311, 312 and 313 are thus connected via said tongue 43. As in the variant in FIG. 6c, the partition 17 comprises two grooves 41, for example perpendicular, situated near the extremities of said tongue 43.

In summary:
in the embodiments depicted in FIGS. 3 to 6, a single tube 51 situated on the side of said hot part 19a is partially closed off;
in the embodiments depicted in FIGS. 7 to 10, two tubes 51 and 52 situated to either side of the transverse partition 17, that is to say a tube 51 of the hot part 19a and a tube 52 of the cold part 19b, are partially closed off;
in the embodiments depicted in FIGS. 3 to 5 and 7 to 9, the one or more said tubes 51 and/or 52 are partially closed off depending on their width;
in the embodiments depicted in FIGS. 6 and 10, the one or more said tubes 51 and/or 52 are partially closed off depending on their length;
in the embodiments depicted in FIGS. 3 and 7, said transverse partition 17 is a simple, flat partition;
in the embodiments depicted in FIGS. 4, 6, 8 and 10, said transverse partition 17 comprises grooves 41 that are perpendicular to it, for example, as means of support; The grooves may also make an angle with the partition equal to 45° in order to form a K if the grooves are joined, although they may be disjointed and the angle may be any other angle;
in the embodiments depicted in FIGS. 5 and 9, said transverse partition 17 is a double partition;
in the embodiments depicted in FIGS. 4 to 6, said seal 25 comprises an alignment failsafe 39 extending on one side of said transverse partition 17;
in the embodiments depicted in FIGS. 6 and 10, said closing part 37 comprises at least one tongue 43, said tongue 43 being able to extend between two transverse straps 31 of said seal 25.

In a general manner, said seal 25 is made from an appropriate elastomer material. Said closing part 37 is advantageously made of the same material as the seal 25. In other words, it is also preferably made from an appropriate elastomer material.

Concerning the assembly of the tubes and the collector plate, the elements are made from aluminum and/or an aluminum alloy, for example, and are attached to one another preferably by brazing.

Furthermore, said partition 17 may be formed through continuity of material with the rest of the cover, in particular by indentation of the external envelope of the cover or by projecting in the interior of the cover. It may even be supported.

It should be noted that variant embodiments are possible, of course, and that the present invention is not restricted to the type of header tank and exchanger described above. In particular, an embodiment, not represented here, in which the heat exchanger comprises two header tanks having double compartments may also be envisaged. In this type of exchanger, two different fluids, in particular at different temperatures, flow through each of the parts of the bundle. In a suchlike embodiment, the one or more said tubes may be partially closed off at each of their openings. In an advantageous manner, said seal of each of the two header tanks is adapted to close off partially the opening of at least one tube.

The invention is also applicable in addition to heat exchangers, of which the bundle of tubes includes a plurality of rows of tubes. In this case, the partially closed-off tube comprises a plurality of tubes located on the same row. In the image of the above description, all the tubes of a same row may be partially closed off. An alternative embodiment is the partial or total closing off of certain tubes, whereas the other tubes of the row are not closed off. In all cases, the virtual tube equivalent to the tubes of the row is a partially closed-off tube.

1. A heat exchanger for a motor vehicle, comprising:
a header tank; and
a bundle of tubes,
said header tank comprising a collector plate, a cover and a seal located between the collector plate and the cover,
said header tank being divided into two compartments by a transverse partition, said compartments being configured to communicate respectively with two parts of the bundle,
said seal isolating said compartments from one another and partially closing off the opening of at least one tube, said partially closed-off tube, opening into said header tank near said transverse partition.

2. The heat exchanger as claimed in claim 1, wherein said partially closed-off tube is the tube opening closest to the transverse partition into the compartment.

3. The heat exchanger as claimed in claim 1, wherein said seal is configured in order to impart in addition peripheral sealing between the plate and the cover.

4. The heat exchanger as claimed in claim 1, wherein said seal comprises an alignment failsafe extending on one side of said transverse partition.

5. The heat exchanger as claimed in claim 1, wherein said seal comprises a closing part adapted to close off partially the opening of the one or more said partially closed-off tubes.

6. The heat exchanger as claimed in claim 5, wherein said seal is substantially rectangular in shape having two large sides and two small sides, the closing part is located on a strap extending between the two large sides.

7. The heat exchanger as claimed in claim 5, wherein said closing part is a localized widening of said strap.

8. The heat exchanger as claimed in claim 1, wherein said transverse partition comprises at least one means of support adapted to apply pressure to said seal in the area of one or more of said partially closed-off tubes.

9. The heat exchanger as claimed in claim 8, wherein the one or more said means of support are grooves perpendicular to said transverse partition.

10. The heat exchanger as claimed in claim 1, wherein said transverse partition comprises two parallel walls connected via a face bearing against the seal.

11. The heat exchanger as claimed in claim 1, wherein the one or more said partially closed-off tubes have a reduced flow cross-section depending on their width.

12. The heat exchanger as claimed in claim 1, wherein the one or more said partially closed-off tubes have a reduced flow cross-section depending on their length.

13. The heat exchanger as claimed in claim 1, wherein between 25 and 75% of the section of one or each of said partially closed-off tubes is closed off.

14. The heat exchanger as claimed in claim 1, wherein one of the two parts, known as the hot part, is at a temperature greater than the temperature of the other part, known as the cold part, the one or more said partially closed-off tubes being situated to the side of said hot part.

15. The heat exchanger as claimed in claim 14, further comprising at least one additional partially closed-off tube in said cold part.
